(19) United States
(12) Patent Application Publication
(10) Pub. No.: US 2003/0141393 A1
(43) Pub. Date: Jul. 31, 2003

(54) Electrostatic powder spray device

(76) Inventors: Leopold Von Keudell, Salem (DE); Otmar Gobl, Altach (AT); Rene Schmid, Hinterforst (CH)

Correspondence Address: John M. Haurykiewicz, FAEGRE & BENSON LLP, 2200 Wells Fargo Center, 90 South Seventh Street, Minneapolis, MN, 55402-3901, US

(21) Appl. No.: 10/351,956

(22) Filed: Jan. 27, 2003

(30) Foreign Application Priority Data
Jan. 29, 2002 (DE) 202 01 338.3

(51) Int. Cl. B05B 5/00

(52) U.S. Cl. 239/690

(57) ABSTRACT

In a powder spray device for the electrostatic coating of workpieces with powder at least partly comprising electrically conductive particles and having a powder channel (10) for delivering the powder to an outlet directed towards the workpiece the powder channel contains a local cross-sectional reduction. The cross-sectional reduction brings about a velocity increase of the powder in the powder channel, thereby preventing an adhesion of the powder to the inner wall of the powder channel.

The invention relates to an electrostatic powder spray device for coating articles with powder, which at least partly comprises electrically conductive particles, with a powder channel or duct for delivering the powder to an outlet directed at the workpiece.

Known powder spray devices of this type contain a powder channel made from electrically non-conductive material for delivering or feeding the coating powder. During coating powder particles can be deposited on the powder channel walls. This powder deposition is particularly pronounced when powders are processed in which the powder does not comprise or does not solely comprise electrically insulating material but is instead wholly or partly constituted by electrically conductive material (so-called metallic powders).

In time due to the depositions on the inside of the powder channel tube an electrically conductive coating is formed and the risk arises that electrical charges are earthed via earthed parts of the powder spray device. Thus, an adequate powder particle charging is no longer possible.

A powder spray device of the aforementioned type as known from DE 197 09 786 makes use of a plug-in nozzle which is intended to permit an adequate charging of the metallic powders.

The problem of the invention is to provide a powder spray device which permits the processing of powders containing chargeable particles, particularly so-called metallic powders, using simple means whilst avoiding a reduction of the electrical charging of the powder particles with an increasing period of use.

This problem is solved by claim 1.

In a powder spray device according to the invention the powder channel contains a local cross-sectional reduction, which effectively prevents a sticking of conductive particles to the inner wall of the powder channel. This is brought about in that the powder is accelerated as a result of the cross-sectional reduction and is therefore brought to a higher level of its kinetic energy, such that powder can no longer adhere to the inner wall.

The cross-sectional reduction should not be excessive, so that pressure losses are not too high, but must also not be too small, so as to ensure an adequate flow rate of the delivered powder in order to avoid wall adhesion.

In practice, a cross-sectional reduction between 70% and 30% of the effective cross-section of the powder channel has proved appropriate, e.g. a cross-sectional reduction of approximately 50%. It is also advantageous if the cross-sectional reduction according to the invention is provided at a distance from the powder channel outlet which is at least five times the effective channel diameter, so that upstream of the powder discharge from the outlet the flow can be calmed.

Further advantageous developments of the invention are given in further subclaims.

Further details of the invention are described in connection with embodiments hereinafter with reference to the attached drawings, wherein

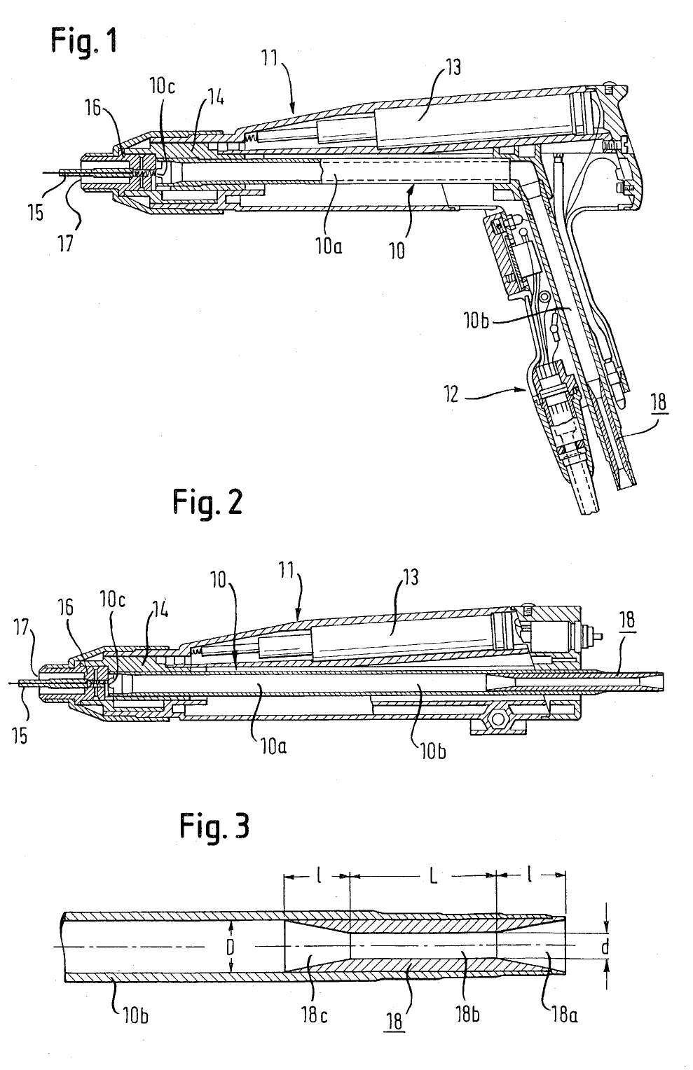

FIG. 1 is a longitudinal section through a manually operable powder spray device according to the invention;

FIG. 2 is a longitudinal section through an automatically operable powder spray device according to the invention; and

FIG. 3 is a longitudinal section through an insert drawn at a larger scale as used in a spray device according to FIG. 1 or 2.

The manually operable powder spray device shown in FIG. 1 has a powder channel or duct 10 with two portions 10a and 10b, whereof one portion 10a is located in the gun barrel 11 and the other portion 10b in the handle 12.

Above the powder channel 10, in conventional manner the barrel 11 receives a high voltage generator 13, which supplies high voltage to a central electrode 15 via a connection sleeve 14, which encloses the downstream end of the powder channel 10.

The powder channel 10 has an outlet opening 10c from which the powder passes via not shown openings in a mouth piece 16 holding the electrode 15 to a gun outlet opening 17 and from there to the not shown workpiece.

In the upstream end of portion 10b of powder channel 10 a replaceable insert 18 is inserted which has a conical entrance portion 18a, a cylindrical, narrow portion 18b and a conical exit portion 18c. The entrance and exit portions 18a, 18c open from a small diameter d of narrow portion 18b to a large diameter D, which corresponds to the effective diameter of the powder channel 10. The length L of the narrow portion 18b at least corresponds to three times the small diameter d, whereas the equal lengths 1 of the entrance portion 18a and exit portion 18c correspond to roughly eight times the diameter difference D-d of the larger diameter D of the powder channel 10 and the small diameter d of the narrow portion 18b.

The distance of insert 18 from the outlet opening 17 of portion 10c of powder channel 10 should be at least five times the effective diameter D of the powder channel 10. This condition would also be fulfilled if the insert 18 were provided at the downstream end of portion 10a in the barrel 11 of the powder spray device according to FIG. 1. With the installation of the insert 18 according to FIG. 1 in the handle 12, replaceability is made more simple.

In the case of the automatic spray gun shown in FIG. 2, for reasons of simplicity identical or identically functioning components are given the same reference numerals.

In this case there is no handle. The upstream portion 10b of the powder channel 10 in which is inserted an identical insert 18 according to FIG. 3, is aligned with the downstream powder channel portion 10a having the outlet opening 17. Here again the distance between the outlet opening 17 and the insert 18 is greater than five times the effective powder channel diameter D.

The features disclosed in the description, drawings and claims can be of significance in implementing the invention, both individually and in random combination.

1. Powder spray device for electrostatic coating of workpieces with powder, which at least partly comprises electrically conductive particles, having a powder channel (10) for delivering the powder to an outlet opening (17) directed towards the workpiece, wherein the powder channel (10) contains a local cross-sectional reduction (18).

2. Powder spray device according to claim 1, wherein the cross-sectional reduction (18) is provided at a distance from the outlet opening (17) of the powder channel (10) corresponding to at least five times the effective diameter (D) of the powder channel.

3. Powder spray device according to claim 1, wherein the cross-sectional reduction (18) is in the range between 70% to 30% of the effective cross-section of the powder channel (10).

4. Powder spray device according to claim 1, wherein the cross-sectional reduction (18) has a substantially conical entrance portion (18a), a substantially conical exit portion (18c) and an intermediate narrow portion (18b) having a constant, small diameter (d).

5. Powder spray device according to claim 1, wherein the cross-sectional reduction (18) is formed by a replaceable insert.

6. Powder spray device according to claim 5, wherein the insert (18) is located in an upstream portion (10b) of the straight powder channel (10) of an automatic spray gun.

7. Powder spray device according to claim 5, wherein the insert (18) is located in a portion (10b) of the powder channel (10) located in the handle (12) of a manually operable spray gun.

8. Powder spray device according to claim 4, wherein the length (L) of the narrow portion (18b) of the insert (18) is at least three times the small diameter (d).

9. Powder spray device according to claim 4, wherein the length (l) of the entrance and exit portions (18a, 18c) is between eight times and one time the difference (D-d) of the effective diameter (D) of the powder channel (10) and the diameter (d) of the narrow portion (18b).
